(19) United States
(12) Patent Application Publication
(10) Pub. No.: US 2026/0119446 A1
(43) Pub. Date: Apr. 30, 2026

(54) SYSTEM-ON-CHIP (SOC) AND METHOD TO ALIGN AND GROUP DATA FROM MULTIPLE PERIPHERAL DEVICES WITH A SYNCHRONOUS SIGNAL

(71) Applicant: MediaTek Singapore Pte. Ltd., Singapore (SG)

(72) Inventors: Hongxu ZHAO, Beijing (CN); Weidong CAO, Beijing (CN)

(21) Appl. No.: 18/928,511

(22) Filed: Oct. 28, 2024

(51) Int. Cl. G06F 15/173

(52) U.S. Cl. CPC G06F 15/17325

(57) ABSTRACT

A system-on-chip (SoC) includes a coprocessor and an application processor. The coprocessor receives data of a plurality of peripheral devices from the peripheral devices based on a notification signal during a current frame. The application processor is electrically connected to the coprocessor. The application processor receives the data of the peripheral devices from the coprocessor based on the notification signal during the current frame. The application processor processes the data of the peripheral devices based on a synchronous signal during the next frame. The notification signal during the current frame is earlier than the synchronous signal during the next frame by a predetermined period.

### BACKGROUND OF THE INVENTION

### Field of the Invention

The present invention relates to an electronic device, and, in particular, to a system-on-chip and a method to align and group data from multiple peripheral devices with a synchronous signal.

### Description of the Related Art

Mobile devices typically include an application processor and an always-on coprocessor. The application processor runs applications and centrally manages a variety of input devices. The always-on coprocessor is a low-power coprocessor that is responsible for sampling various input devices. The always-on coprocessor timely passes the sampling results of the input devices to the application processor for subsequent centralized processing.

However, the sampling signal of the input device is not synchronized with the synchronous signal, called Vsync APP. Discrete sampling will cause the always-on coprocessor to be frequently woken up, resulting in power loss. The application consumes or processes all input device information within one frame according to the Vsync APP heartbeat. However, the discrete data stream of the input device is sent to the application, which causes the application processor to be woken up frequently, ultimately causing power loss.

### BRIEF SUMMARY OF THE INVENTION

An embodiment of the present invention provides a system-on-chip (SoC). The SoC includes a coprocessor and an application processor. The coprocessor receives data of a plurality of peripheral devices from the peripheral devices based on a notification signal during a current frame. The application processor is electrically connected to the coprocessor. The application processor receives the data of the peripheral devices from the coprocessor based on the notification signal during the current frame, and processes the data of the peripheral devices based on a synchronous signal during the next frame. The notification signal during the current frame is earlier than the synchronous signal during the next frame by a predetermined period.

According to the SoC described above, the notification signal and the synchronous signal are periodic signals. The current frame and the next frame are defined between two adjacent synchronous signals. The current frame is earlier than the next frame, and the current frame is followed by the next frame.

The SoC further includes a peripherals input controller. The peripherals input controller is electrically connected to the coprocessor and the application processor. The peripherals input controller receives the data of the peripheral devices from the peripheral devices and bypasses the data of the peripheral devices to the coprocessor.

The SoC further includes a notification controller. The notification controller is electrically connected to the coprocessor and the application processor. The notification controller generates the notification signal based on the synchronous signal from the application processor, and outputs the notification signal to the peripheral devices and the coprocessor.

According to the SoC described above, the notification controller includes a counting register, a reference register, and a comparator. The counting register receives and bypasses a clock signal. The reference register receives and bypasses the synchronous signal. The comparator receives the clock signal and the synchronous signal, and outputs the notification signal during the current frame to the peripheral devices and the coprocessor at the beginning of the predetermined period before the synchronous signal during the next frame is received.

According to the SoC described above, the clock signal is generated by a crystal resonator included in the SoC.

According to the SoC described above, the application processor configures a software timer to count the actual period before the synchronous signal during the next frame is generated, and calls an interrupt service routine (ISR) to output the notification signal to the peripheral devices and the coprocessor when the actual period is equal to the predetermined period.

According to the SoC described above, the application processor sends information of the predetermined period to the coprocessor, and the coprocessor configures a software timer to count the actual period before the synchronous signal during the next frame is generated, and calls an ISR to output the notification signal to the peripheral devices when the actual period is equal to the predetermined period.

The SoC further includes a notification controller. The notification controller includes a timeout timer. The timeout timer is electrically connected to the coprocessor, the application processor, and the peripheral devices. The timeout timer receives the synchronous signal and information of the predetermined period, counts the actual period before the synchronous signal during the next frame is generated, and outputs the notification signal to the coprocessor, the application processor, and the peripheral devices having interrupt controllers when the actual period is equal to the predetermined period. The application processor includes an interrupt controller. The interrupt controller receives the notification signal from the timeout timer, and calls a task to output a control signal to the peripheral devices having no interrupt controllers based on the notification signal, so that the peripheral devices having no interrupt controllers send their data to the coprocessor based on the control signal.

According to the SoC described above, the application processor configures a software timer to count the actual period before the synchronous signal during the next frame is generated, calls an ISR to output the notification signal to the peripheral devices having interrupt controllers and the coprocessor when the actual period is equal to the predetermined period, and calls a task to output a control signal to the peripheral devices having no interrupt controllers based on the notification signal.

The SoC further includes a notification controller. The notification controller includes a timeout timer. The timeout timer is electrically connected to the coprocessor, the application processor, and the peripheral devices. The timeout timer receives the synchronous signal, counts the actual period before the synchronous signal during the next frame is generated, and outputs the notification signal to the coprocessor, the application processor, and the peripheral devices having microcontrollers when the actual period is equal to the predetermined period, so that an sampling rate of the peripheral devices having microcontrollers is calibrated by the notification signal. The coprocessor calibrates its sampling rate to sample the peripheral devices having no microcontrollers based on the notification signal.

The SoC further includes a notification controller. The notification controller is electrically connected to the coprocessor, the application processor, and the peripheral devices. The notification controller receives the synchronous signal and information of the predetermined period, counts the actual period before the synchronous signal during the next frame is generated, and outputs the notification signal to the coprocessor, and the peripheral devices having no first-in-first-out (FIFO) buffers when the actual period is equal to the predetermined period. The coprocessor includes a FIFO buffer. The FIFO buffer is electrically connected to the application processor and the peripheral devices having no FIFO buffers. The FIFO buffer receives data of the peripheral devices having no FIFO buffers, and sends the data of the peripheral devices having no FIFO buffers to the application processor in response to receiving the notification signal from the notification controller.

The SoC further includes a notification controller. The notification controller is electrically connected to the coprocessor, the application processor, and the peripheral devices. The notification controller receives the synchronous signal and information of the predetermined period, counts the actual period before the synchronous signal during the next frame is generated, and outputs the notification signal to the coprocessor, and the peripheral devices. The peripheral devices include a FIFO buffer. The FIFO buffer is electrically connected to the notification controller and the coprocessor. The FIFO buffer stores data of the peripheral devices, and sends the data of the peripheral devices to the coprocessor in response to receiving the notification signal from the notification controller. The coprocessor sends the data of the peripheral devices to the application processor in response to receiving the notification signal from the notification controller.

An embodiment of the present invention also provides a method to align and group data from multiple peripheral devices with a synchronous signal. The method is applicable to a SoC including a coprocessor and an application processor, which are electrically connected to each other. The method includes the following steps. The coprocessor receives the data of the peripheral devices from the peripheral devices based on a notification signal during a current frame. The application processor receives the data of the peripheral devices from the coprocessor based on the notification signal during the current frame. The application processor processes the data of the peripheral devices based on a synchronous signal during the next frame. The notification signal during the current frame is earlier than the synchronous signal during the next frame by a predetermined period.

According to the method described above, the notification signal and the synchronous signal are periodic signals. The current frame and the next frame are defined between two adjacent synchronous signals. The current frame is earlier than the next frame, and the current frame is followed by the next frame.

According to the method described above, the SoC further includes a notification controller. The method further includes the following steps. The notification controller generates the notification signal based on the synchronous signal from the application processor. The notification controller outputs the notification signal to the peripheral devices and the coprocessor.

The method further includes the following steps. The application processor configures a software timer to count the actual period before the synchronous signal during the next frame is generated. The application processor calls an ISR to output the notification signal to the peripheral devices and the coprocessor when the actual period is equal to the predetermined period.

The method further includes the following steps. The application processor sends information of the predetermined period to the coprocessor. The coprocessor configures a software timer to count the actual period before the synchronous signal during the next frame is generated. The coprocessor calls an ISR to output the notification signal to the peripheral devices when the actual period is equal to the predetermined period.

According to the method described above, the SoC further includes a notification controller having a timeout timer, and the application processor includes an interrupt controller. The method further includes the following steps. The timeout timer receives the synchronous signal and information of the predetermined period. The timeout timer counts the actual period before the synchronous signal during the next frame is generated. The timeout timer outputs the notification signal to the coprocessor, the application processor, and the peripheral devices having interrupt controllers when the actual period is equal to the predetermined period. The application processor receives the notification signal from the timeout timer. The application processor calls a task to output a control signal to the peripheral devices having no interrupt controllers based on the notification signal, so that the peripheral devices having no interrupt controllers send their data to the coprocessor based on the control signal.

According to the method described above, the SoC further includes a notification controller. The peripheral devices include a FIFO buffer. The method further includes the following steps. The notification controller receives the synchronous signal and information of the predetermined period. The notification controller counts the actual period before the synchronous signal during the next frame is generated. The notification controller outputs the notification signal to the coprocessor and the peripheral devices having no first-in-first-out (FIFO) buffers when the actual period is equal to the predetermined period. The FIFO buffer stores data of the peripheral devices. The FIFO buffer sends the data of the peripheral devices to the coprocessor in response to receiving the notification signal from the notification controller. The coprocessor sends the data of the peripheral devices to the application processor in response to receiving the notification signal from the notification controller.

### BRIEF DESCRIPTION OF THE DRAWINGS

The present invention can be more fully understood by reading the subsequent detailed description and examples with references made to the accompanying drawings, wherein:

FIG. 1 shows a schematic diagram of a system-on-chip (SoC) 100 in accordance with some embodiments of the present invention;

FIG. 2 shows a time sequence diagram of data transmission between SoC 100 and peripheral devices in FIG. 1 in accordance with some embodiments of the present invention;

FIG. 3 shows a detail schematic diagram of the SoC 100 in FIG. 1 in accordance with some embodiments of the present invention;

FIG. 4 shows a detail schematic diagram of the SoC 100 in FIG. 1 in accordance with some embodiments of the present invention;

FIG. 5 shows a detail schematic diagram of the SoC 100 in FIG. 1 in accordance with some embodiments of the present invention;

FIG. 6 shows a detail schematic diagram of the SoC 100 in FIG. 1 in accordance with some embodiments of the present invention;

FIG. 7 shows a detail schematic diagram of the SoC 100 in FIG. 1 in accordance with some embodiments of the present invention;

FIG. 8 shows a detail schematic diagram of the SoC 100 in FIG. 1 in accordance with some embodiments of the present invention;

FIG. 9 shows a detail schematic diagram of the SoC 100 in FIG. 1 in accordance with some embodiments of the present invention;

FIG. 10 shows a detail schematic diagram of the SoC 100 in FIG. 1 in accordance with some embodiments of the present invention; and

FIG. 11 shows a flow chart of a method to align and group data from multiple peripheral devices with a synchronous signal in accordance with some embodiments of the present invention.

### DETAILED DESCRIPTION OF THE INVENTION

In order to make the above purposes, features, and advantages of some embodiments of the present invention more comprehensible, the following is a detailed description in conjunction with the accompanying drawing.

Certain terms are used throughout the description and following claims to refer to particular components. As one skilled in the art will understand, electronic equipment manufacturers may refer to a component by different names. This document does not intend to distinguish between components that differ in name but not function. It is understood that the words “comprise”, “have” and “include” are used in an open-ended fashion, and thus should be interpreted to mean “include, but not limited to . . . ”. Thus, when the terms “comprise”, “have” or “include” used in the present invention are used to indicate the existence of specific technical features, values, method steps, operations, units or components. However, it does not exclude the possibility that more technical features, numerical values, method steps, work processes, units, components, or any combination of the above can be added.

The directional terms used throughout the description and following claims, such as: “on”, “up”, “above”, “down”, “below”, “front”, “rear”, “back”, “left”, “right”, etc., are only directions referring to the drawings. Therefore, the directional terms are used for explaining and not used for limiting the present invention. Regarding the drawings, the drawings show the general characteristics of methods, structures, or materials used in specific embodiments. However, the drawings should not be construed as defining or limiting the scope or properties encompassed by these embodiments. For example, for clarity, the relative size, thickness, and position of each layer, each area, or each structure may be reduced or enlarged.

When the corresponding component such as layer or area is referred to as being “on another component”, it may be directly on this other component, or other components may exist between them. On the other hand, when the component is referred to as being “directly on another component (or the variant thereof)”, there is no component between them. Furthermore, when the corresponding component is referred to as being “on another component”, the corresponding component and the other component have a disposition relationship along a top-view/vertical direction, the corresponding component may be below or above the other component, and the disposition relationship along the top-view/vertical direction is determined by the orientation of the device.

It should be understood that when a component or layer is referred to as being “connected to” another component or layer, it can be directly connected to this other component or layer, or intervening components or layers may be present. In contrast, when a component is referred to as being “directly connected to” another component or layer, there are no intervening components or layers present.

The electrical connection or coupling described in this disclosure may refer to direct connection or indirect connection. In the case of direct connection, the endpoints of the components on the two circuits are directly connected or connected to each other by a conductor line segment, while in the case of indirect connection, there are switches, diodes, capacitors, inductors, resistors, other suitable components, or a combination of the above components between the endpoints of the components on the two circuits, but the intermediate component is not limited thereto.

The words “first”, “second”, and “third” are used to describe components. They are not used to indicate the priority order of or advance relationship, but only to distinguish components with the same name.

It should be noted that the technical features in different embodiments described in the following can be replaced, recombined, or mixed with one another to constitute another embodiment without depart in from the spirit of the present invention.

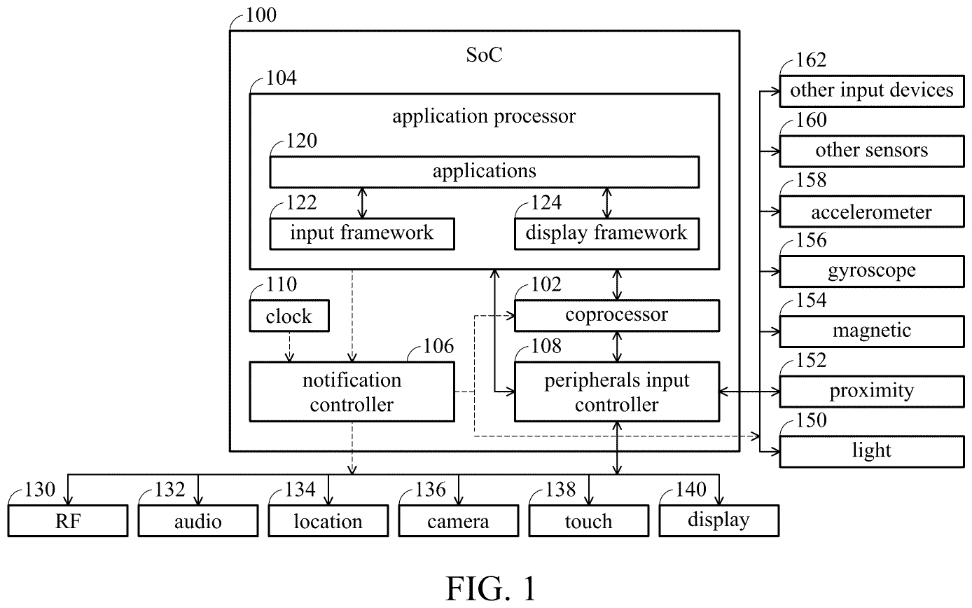

FIG. 1 shows a schematic diagram of a system-on-chip (SoC) 100 in accordance with some embodiments of the present invention. As shown in FIG. 1, the SoC 100 includes a coprocessor 102, an application processor 104, a notification controller 106, a peripherals input controller 108, and a clock 110. In some embodiments, the coprocessor 102 is an always-on-domain coprocessor, but the present invention is not limited thereto. The application processor 104 executes applications 120, an input framework 122, and a display framework 124. For example, the application processor 104 executes the input framework 122 to indirectly receive data from multiple peripheral devices. In some embodiments, the peripheral devices include an RF circuit 130, an audio device 132, a location device 134, a camera 136, a touch sensor 138, a display device 140, a light sensor 150, a proximity sensor 152, a magnetic sensor 154, a gyroscope 156, an accelerometer 158, other sensors 160, and other input devices, but the present invention is not limited thereto. The application processor 104 executes the display framework 124 to process display data from the coprocessor 102. The processor 104 executes the applications to process (for example, render) the display data from the coprocessor 102.

In some embodiments, the coprocessor 102 receives the data of the peripheral devices from the peripheral devices based on a notification signal during a current frame. For example, the peripheral devices send their own data to the coprocessor 102 in response to receiving the notification signal from the notification controller 106. The application processor 104 is electrically connected to the coprocessor 102. The application processor 104 receives the data of the peripheral devices from the coprocessor 102 based on the notification signal during the current frame, and processes the data of the peripheral devices based on a synchronous signal during the next frame. For example, the coprocessor 102 sends the collected data of the peripheral devices to the application processor 104 in response to receiving the notification signal from the notification controller 106. The notification signal during the current frame is earlier than the synchronous signal during the next frame by a predetermined period. In some embodiments, the notification signal and the synchronous signal are periodic signals. The current frame and the next frame are defined between two adjacent synchronous signals. The current frame is earlier than the next frame, and the current frame is followed by the next frame.

The notification controller 106 is electrically connected to the coprocessor 102 and the application processor 104. The notification controller 106 generates the notification signal based on the synchronous signal from the application processor 104, and outputs the notification signal to the peripheral devices and the coprocessor 102. The notification controller 106 is further electrically to a clock source 110. The clock source 110 outputs a clock signal to the notification controller 106. The peripherals input controller 108 is electrically connected to the coprocessor 102 and the application processor 104. The peripherals input controller 108 receives the data of the peripheral devices from the peripheral devices and bypasses the data of the peripheral devices to the coprocessor 102.

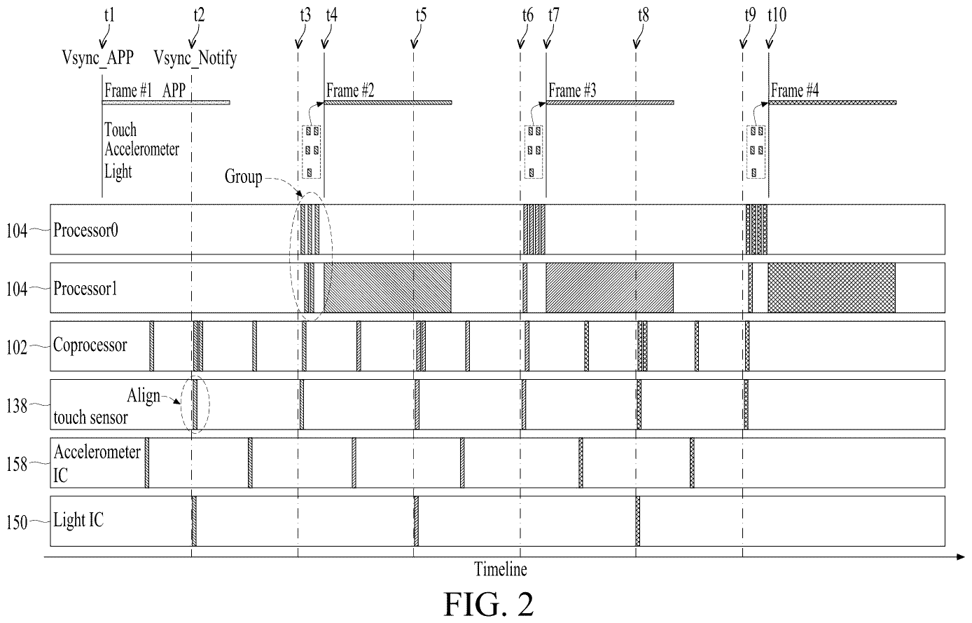

FIG. 2 shows a time sequence diagram of data transmission between SoC 100 and the peripheral devices in FIG. 1 in accordance with some embodiments of the present invention. It is assumed that the transmission frequency of a synchronous signal Vsync APP is 120 Hz, the transmission frequency of the data sending from the touch sensor 138 is 240 Hz, the transmission frequency of the data sending from the accelerometer 158 is 200 Hz, and the transmission frequency of the data sending from the light sensor 150 is 100 Hz. In some embodiments, the synchronous signal Vsync APP is from a crystal resonator included in the SoC 100, but the present invention is not limited thereto. As shown in FIG. 2, the application processor 104 executes two threads, such as a thread processor0 and a thread processor1. A frame #1 is defined between time point t1 and time point t3. At time point t1, the synchronous signal Vsync APP is triggered, the application processor 104 starts to process the data of peripheral devices received before the synchronous signal Vsync APP is triggered at time point t1. The accelerometer 158 follows its own rhythm to send its own data to the coprocessor 102 without considering a notification signal Vsync Notify between time point t1 and time point t2.

At time point t2, the notification signal Vsync Notify is triggered, the touch sensor 138 and the light sensor 150 send (or upload) their own data to the coprocessor 102 in response to receiving the notification signal Vsync Notify. That is, the data from the touch sensor 138 and the light sensor 150 are aligned when the notification signal Vsync Notify is triggered at time point t2. Therefore, the coprocessor 102 receives the data from the touch sensor 138 and the light sensor 150 after the notification signal Vsync Notify is triggered at time point t2.

The accelerometer 158 follows its own rhythm to send its own data to the coprocessor 102 again without considering the notification signal Vsync Notify between time point t2 and time point t3. At time point t3, the notification signal Vsync Notify is triggered, the touch sensor 138 sends its own data to the coprocessor 102 in response to receiving the notification signal Vsync Notify. The coprocessor 102 sends (or uploads) the total 5 data from the touch sensor 138, the light sensor 150, and the accelerometer 158 to the application processor 104 in response to receiving the notification signal Vsync Notify. Therefore, the application processor 104 receives the total 5 data from the touch sensor 138, the light sensor 150, and the accelerometer 158 based on the notification signal Vsync Notify during frame #1. In detail, the total 5 data include 2 data from the touch sensor 138, 1 data from the light sensor 150, and 2 data from the accelerometer 158. In some embodiments, the application processor 104 receives 3 data through the thread processor0, and receives 2 data through the thread processor1, but the present invention is not limited thereto. The application processor 104 allocates the total 5 data to the thread processor0 and the thread processor1 based on the current computility loading. The notification signal Vsync Notify at time point t3 during frame #1 is earlier than the synchronous signal Vsync APP at time point t4 during frame #2 by a predetermined period, which is a period between time point t3 and time point t4.

A frame #2 is defined between time point t4 and time point t7. At time point t4, the synchronous signal Vsync APP is triggered, the application processor 104 processes (for example, renders) the data from the touch sensor 138, the light sensor 150, and the accelerometer 158 based on the synchronous signal Vsync APP during frame #2. As shown in FIG. 2, the application processor 104 processes the data from the touch sensor 138, the light sensor 150, and the accelerometer 158 received during frame #1 through the thread processor1, so that a part of the application processor 104 that executing the thread processor0 may enter into a sleep mode between time point t4 and time point t6, resulting in power saving of the application processor 104. The accelerometer 158 follows its own rhythm to send its own data to the coprocessor 102 without considering the notification signal Vsync Notify between time point t4 and time point t5. At time point t5, the notification signal Vsync Notify is triggered, the touch sensor 138 and the light sensor 150 send (or upload) their own data to the coprocessor 102 in response to receiving the notification signal Vsync Notify. That is, the data from the touch sensor 138 and the light sensor 150 are aligned when the notification signal Vsync Notify is triggered at time point t5.

The accelerometer 158 follows its own rhythm to send its own data to the coprocessor 102 again without considering the notification signal Vsync Notify between time point t5 and time point t6. At time point t6, the notification signal Vsync Notify is triggered, the touch sensor 138 sends its own data to the coprocessor 102 in response to receiving the notification signal Vsync Notify. The coprocessor 102 sends (or uploads) the total 5 data from the touch sensor 138, the light sensor 150, and the accelerometer 158 to the application processor 104 in response to receiving the notification signal Vsync Notify. Therefore, the application processor 104 receives the total 5 data from the touch sensor 138, the light sensor 150, and the accelerometer 158 based on the notification signal Vsync Notify during frame #2. In detail, the total 5 data include 2 data from the touch sensor 138, 1 data from the light sensor 150, and 2 data from the accelerometer 158. In some embodiments, the application processor 104 receives 4 data through the thread processor0, and receives 1 data through the thread processor1, but the present invention is not limited thereto. The notification signal Vsync Notify at time point t6 during frame #2 is earlier than the synchronous signal Vsync APP at time point t7 during frame #3 by a predetermined period, which is a period between time point t6 and time point t7.

A frame #3 is defined between time point t7 and time point t10. At time point t7, the synchronous signal Vsync APP is triggered, the application processor 104 processes (for example, renders) the data from the touch sensor 138, the light sensor 150, and the accelerometer 158 based on the synchronous signal Vsync APP during frame #3. As shown in FIG. 2, the application processor 104 processes the data from the touch sensor 138, the light sensor 150, and the accelerometer 158 received during frame #2 through the thread processor1, so that the part of the application processor 104 that executing the thread processor0 may enter into the sleep mode between time point t7 and time point t9, resulting in power saving of the application processor 104. The accelerometer 158 follows its own rhythm to send its own data to the coprocessor 102 without considering the notification signal Vsync Notify between time point t7 and time point t8. At time point t8, the notification signal Vsync Notify is triggered, the touch sensor 138 and the light sensor 150 send (or upload) their own data to the coprocessor 102 in response to receiving the notification signal Vsync Notify. That is, the data from the touch sensor 138 and the light sensor 150 are aligned when the notification signal Vsync Notify is triggered at time point t8.

The accelerometer 158 follows its own rhythm to send its own data to the coprocessor 102 again without considering the notification signal Vsync Notify between time point t8 and time point t9. At time point t9, the notification signal Vsync Notify is triggered, the touch sensor 138 sends its own data to the coprocessor 102 in response to receiving the notification signal Vsync Notify. The coprocessor 102 sends (or uploads) the total 5 data from the touch sensor 138, the light sensor 150, and the accelerometer 158 to the application processor 104 in response to receiving the notification signal Vsync Notify. Therefore, the application processor 104 receives the total 5 data from the touch sensor 138, the light sensor 150, and the accelerometer 158 based on the notification signal Vsync Notify during frame #3. In detail, the total 5 data include 2 data from the touch sensor 138, 1 data from the light sensor 150, and 2 data from the accelerometer 158. In some embodiments, the application processor 104 receives 4 data through the thread processor0, and receives 1 data through the thread processor1, but the present invention is not limited thereto. The notification signal Vsync Notify at time point t9 during frame #3 is earlier than the synchronous signal Vsync APP at time point t10 during frame #4 by a predetermined period, which is a period between time point t9 and time point t10.

A frame #4 is defined after time point t4. At time point t10, the synchronous signal Vsync APP is triggered, the application processor 104 processes (for example, renders) the data from the touch sensor 138, the light sensor 150, and the accelerometer 158 based on the synchronous signal Vsync APP during frame #4. As shown in FIG. 2, the application processor 104 processes the data from the touch sensor 138, the light sensor 150, and the accelerometer 158 received during frame #3 through the thread processor1, so that the part of the application processor 104 that executing the thread processor0 may enter into the sleep mode after time point t10, resulting in power saving of the application processor 104.

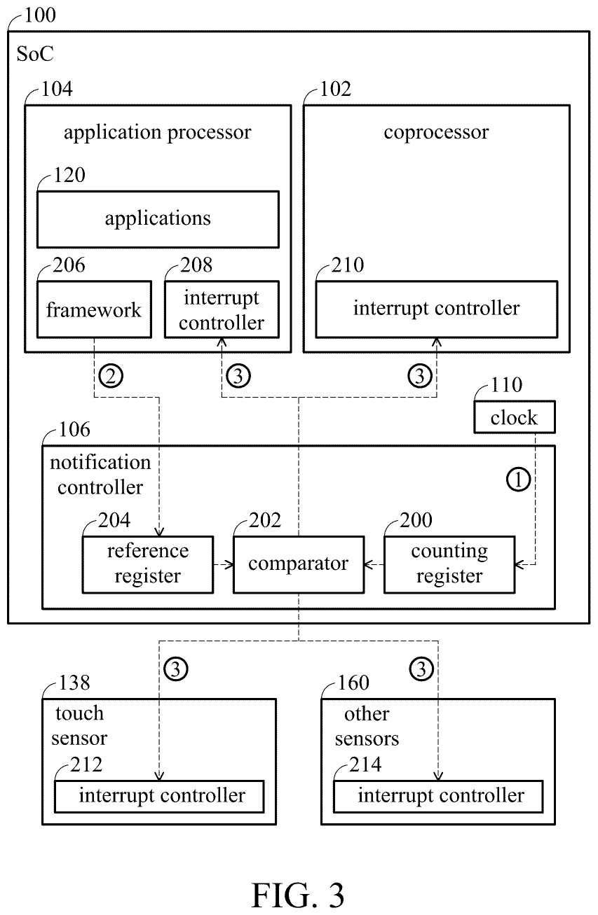

FIG. 3 shows a detail schematic diagram of the SoC 100 in FIG. 1 in accordance with some embodiments of the present invention. As shown in FIG. 3, the SoC 100 includes the coprocessor 102, the application processor 104, the notification controller 106, and the clock source 110. The coprocessor 102 includes an interrupt controller 210. The application processor 104 includes an interrupt controller 208. The application processor 104 executes a framework 206 to send the synchronous signal (for example, the synchronous signal Vsync APP in FIG. 2) to the notification controller 106, such as action 2. The notification controller 106 includes a counting register 200, a comparator 202, and a reference register 204. The counting register 200 receives and bypasses a clock signal from the clock source 110, such as action 1. The reference register 204 receives and bypass the synchronous signal from the framework 206. The comparator 202 receives the clock signal and the synchronous signal, and outputs the notification signal during the current frame (for example, frame #1 in FIG. 2) to the touch senor 138, other sensors 160, the interrupt controller 210 of the coprocessor 102, and the interrupt controller 208 of the application processor 104 at the beginning of the predetermined period (for example, time point t3 in FIG. 2) before the synchronous signal during the next frame (for example, frame #2 in FIG. 2) is received, such as action 3. In some embodiments of FIG. 3, the touch senor 138 includes an interrupt controller 212, and the other sensors 160 also include an interrupt controller 214. In some embodiments, the clock source 110 is a crystal resonator included in the SoC 100, but the present invention is not limited thereto. FIG. 3 discloses some embodiments of the present invention to align the data from the peripheral devices with the synchronous signal.

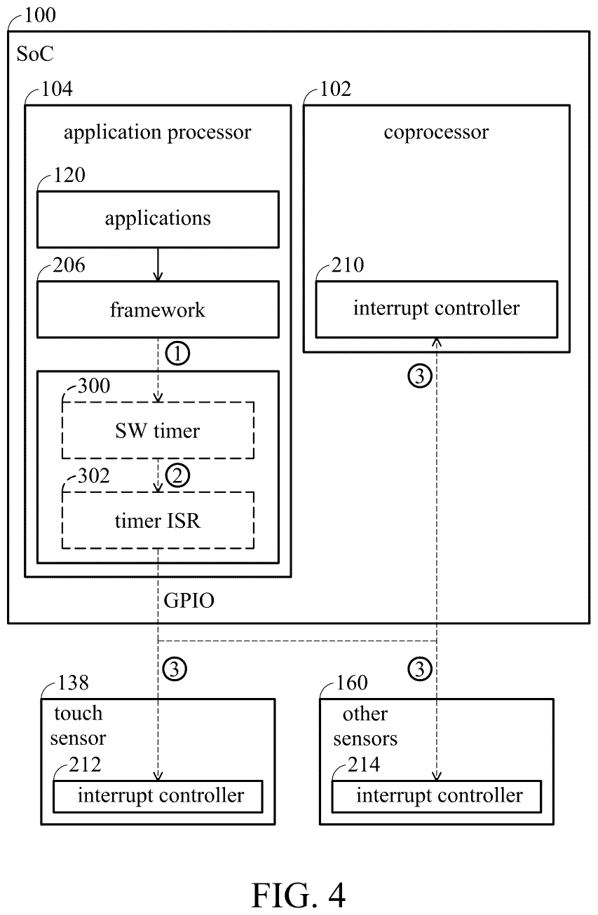

FIG. 4 shows a detail schematic diagram of the SoC 100 in FIG. 1 in accordance with some embodiments of the present invention. As shown in FIG. 4, the SoC 100 includes the coprocessor 102 and the application processor 104. The coprocessor 102 includes an interrupt controller 210. The application processor 104 executes the framework 206 to send out the synchronous signal, such as action 1. The application processor 104 configures a software timer 300 to count the actual period before the synchronous signal during the next frame (for example, frame #2 in FIG. 2) is generated, and calls an interrupt service routine (ISR) 302 to output the notification signal to the touch senor 138, the other sensors 160, and the interrupt controller 210 of the coprocessor 102, such as action 3, when the actual period is equal to the predetermined period (for example, a period between time point t3 and time point t4 in FIG. 2). In some embodiments, when the actual period is equal to the predetermined period, the software timer 300 sends an enable signal to the ISR 302, such as action 2, so that the ISR 302 outputs the notification signal to the touch senor 138, the other sensors 160, and the interrupt controller 210 of the coprocessor 102 through general-purpose input/output (GPIO). In some embodiments of FIG. 4, the touch senor 138 includes the interrupt controller 212, and the other sensors 160 also include the interrupt controller 214. FIG. 4 discloses some embodiments of the present invention to align the data from the peripheral devices with the synchronous signal.

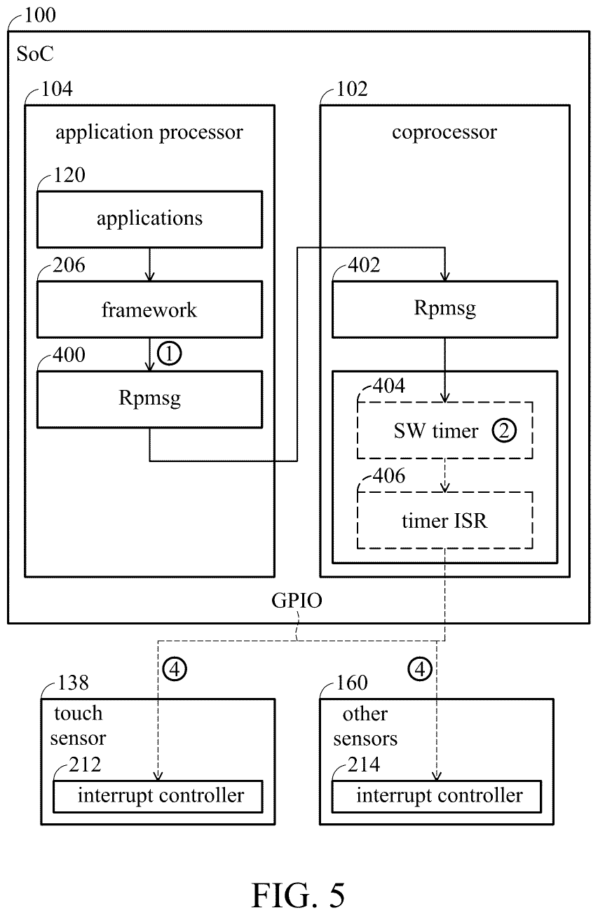

FIG. 5 shows a detail schematic diagram of the SoC 100 in FIG. 1 in accordance with some embodiments of the present invention. As shown in FIG. 5, the SoC 100 includes the coprocessor 102 and the application processor 104. The application processor 104 executes the framework 206 to send out the synchronous signal and information of the predetermined period, such as action 0. The synchronous signal and the information of the predetermined period is sent to the coprocessor 102 through a transmission protocol 400. The coprocessor 102 receives the synchronous signal and the information of the predetermined period through a transmission protocol 402. In some embodiments, the transmission protocols 400 and 402 may be Rpmsg, but the present invention is not limited thereto. Next, the coprocessor 102 configures a software timer 404 to count the actual period before the synchronous signal during the next frame (for example, frame #2 in FIG. 2) is generated, and calls an interrupt service routine (ISR) 406 to output the notification signal to the touch senor 138 and the other sensors 160 through GPIO when the actual period is equal to the predetermined period, such as action 4. In some embodiments of FIG. 5, the touch senor 138 includes the interrupt controller 212, and the other sensors 160 also include the interrupt controller 214. FIG. 5 discloses some embodiments of the present invention to align the data from the peripheral devices with the synchronous signal.

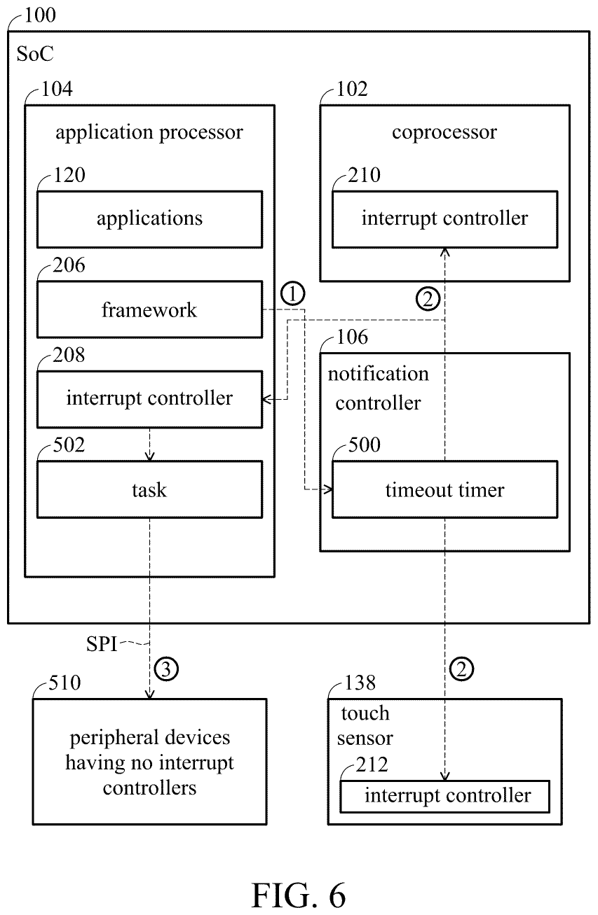

FIG. 6 shows a detail schematic diagram of the SoC 100 in FIG. 1 in accordance with some embodiments of the present invention. As shown in FIG. 6, the SoC 100 includes the coprocessor 102, the application processor 104, and the notification controller 106. The application controller 104 include the interrupt controller 208. The coprocessor 102 includes the interrupt controller 210. The notification controller 106 includes a timeout timer 500. The timeout timer 500 is electrically connected to the coprocessor 102, the application processor 104, the touch sensor 138 and the peripheral devices having no interrupt controllers. The timeout timer 500 receives the synchronous signal and information of the predetermined period from the framework 206, such as action 1, counts the actual period before the synchronous signal during the next frame is generated, and outputs the notification signal to the coprocessor 102, the application processor 104, and the touch sensor 138, such as action 2, when the actual period is equal to the predetermined period. The interrupt controller 208 receives the notification signal from the timeout timer 500, and calls a task 502 to output a control signal to peripheral devices having no interrupt controllers 510 based on the notification signal through serial peripheral interface bus (SPI), such as action 33, so that the peripheral devices having no interrupt controllers 510 send their data to the coprocessor 102 based on the control signal. In some embodiments of FIG. 5, the touch senor 138 includes the interrupt controller 212. FIG. 6 discloses some embodiments of the present invention to align the data from the peripheral devices with the synchronous signal.

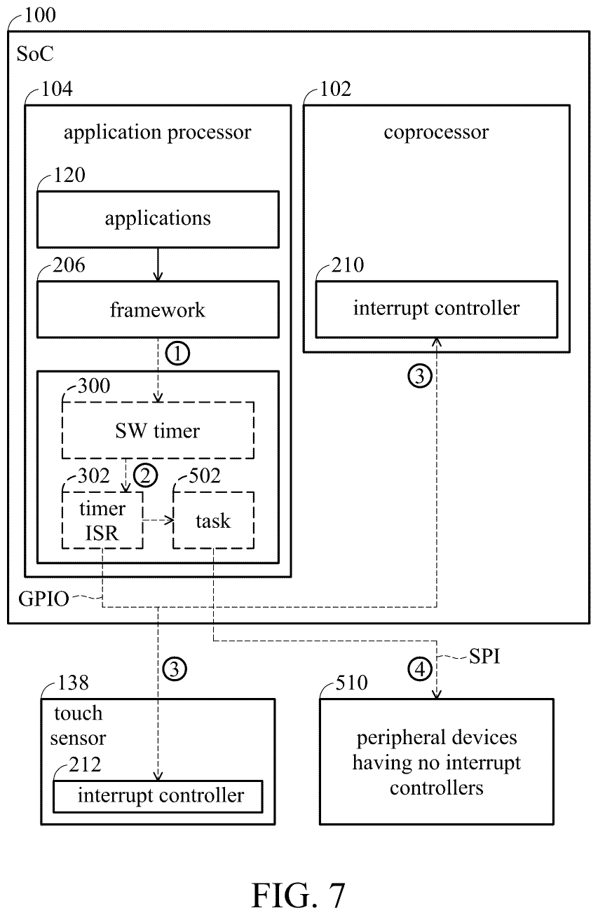

FIG. 7 shows a detail schematic diagram of the SoC 100 in FIG. 1 in accordance with some embodiments of the present invention. As shown in FIG. 7, the SoC 100 includes the coprocessor 102 and the application processor 104. The coprocessor 102 includes the interrupt controller 210. The coprocessor 102 includes an interrupt controller 210. The application processor 104 executes the framework 206 to send out the synchronous signal, such as action 1. The application processor 102 configures the software timer 300 to count the actual period before the synchronous signal during the next frame is generated, and calls an interrupt service routine (ISR) 302 to output the notification signal to the peripheral devices having interrupt controllers, such as the touch sensor 138, and the coprocessor 102 when the actual period is equal to the predetermined period, such as action 3. The application processor 102 calls the task 502 to output a control signal to the peripheral devices having no interrupt controllers 510 based on the notification signal through SPI, such as action 4. In some embodiments, when the actual period is equal to the predetermined period, the software timer 300 sends an enable signal to the ISR 302, such as action 2, so that the ISR 302 outputs the notification signal to the touch senor 138 and the coprocessor 102 through GPIO. FIG. 7 discloses some embodiments of the present invention to align the data from the peripheral devices with the synchronous signal.

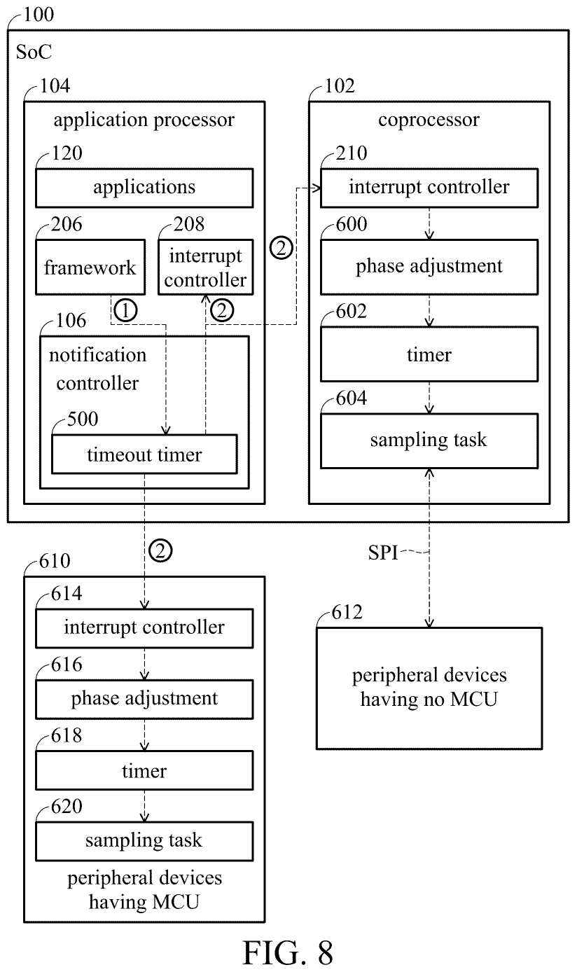

FIG. 8 shows a detail schematic diagram of the SoC 100 in FIG. 1 in accordance with some embodiments of the present invention. As shown in FIG. 8, the SoC 100 includes the coprocessor 102, the application processor 104, and the notification controller 106. The coprocessor 102 includes the interrupt controller 210. The application processor 104 incudes the interrupt controller 208. The notification controller 106 includes the timeout timer 500. The timeout timer 500 is electrically connected to the coprocessor 102, the application processor 104, and peripheral devices having microcontrollers 610. The peripheral devices having microcontrollers 610 include an interrupt controller 614 and a timer 618. The timeout timer 500 receives the synchronous signal from the framework 206, such as action 1, counts the actual period before the synchronous signal during the next frame is generated, and outputs the notification signal to the coprocessor 102, the application processor 104, and the peripheral devices having microcontrollers 610, such as action 2, when the actual period is equal to the predetermined period, so that an sampling rate of the peripheral devices having microcontrollers 610 is calibrated by the notification signal. For example, after the interrupt controller 614 receives the notification signal from the timeout timer 500, the peripheral devices having microcontrollers 610 perform phase adjustment 616 on its original clock signal based on the notification signal. The peripheral devices having microcontrollers 610 resets the timer 618 to output a clock signal calibrated by the notification signal. The peripheral devices having microcontrollers 610 performs sampling task 620 based on the calibrated clock signal with a sampling rate that is calibrated by the notification signal.

The coprocessor 102 calibrates its sampling rate to sample the peripheral devices having no microcontrollers 612 through SPI based on the notification signal. For example, after the interrupt controller 210 receives the notification signal from the timeout timer 500, the coprocessor 102 performs phase adjustment 600 on its original clock signal based on the notification signal. The coprocessor 102 resets the timer 602 to output a clock signal calibrated by the notification signal. The coprocessor 102 resets the timer 602 to output a clock signal calibrated by the notification signal. The coprocessor 102 performs sampling task 604 to sample the peripheral devices having no microcontrollers 612 based on the calibrated clock signal with a sampling rate that is calibrated by the notification signal. FIG. 8 discloses some embodiments of the present invention to align the data from the peripheral devices with the synchronous signal.

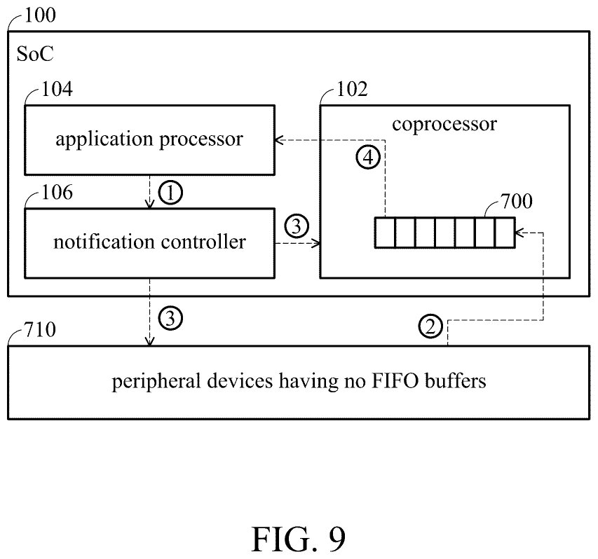

FIG. 9 shows a detail schematic diagram of the SoC 100 in FIG. 1 in accordance with some embodiments of the present invention. As shown in FIG. 9, the SoC 100 includes the coprocessor 102, the application processor 104, and the notification controller 106. The coprocessor 102 includes a first-in-first-out (FIFO) buffer 700. The notification controller 106 is electrically connected to the coprocessor 102, the application processor 104, and peripheral devices having no FIFO buffers 710. The notification controller 106 receives the synchronous signal and information of the predetermined period, such as action 1, counts the actual period before the synchronous signal during the next frame is generated, and outputs the notification signal to the coprocessor 102, and the peripheral devices having no FIFO buffers 710, such as action 3, when the actual period is equal to the predetermined period. The FIFO buffer 700 is electrically connected to the application processor 104 and the peripheral devices having no FIFO buffers 710. The FIFO buffer 700 receives data of the peripheral devices having no FIFO buffers, such as action 2, and sends the data of the peripheral devices having no FIFO buffers to the application processor 104 in response to receiving the notification signal from the notification controller 106, such as action 4. FIG. 9 discloses some embodiments of the present invention to group the data from the peripheral devices with the synchronous signal.

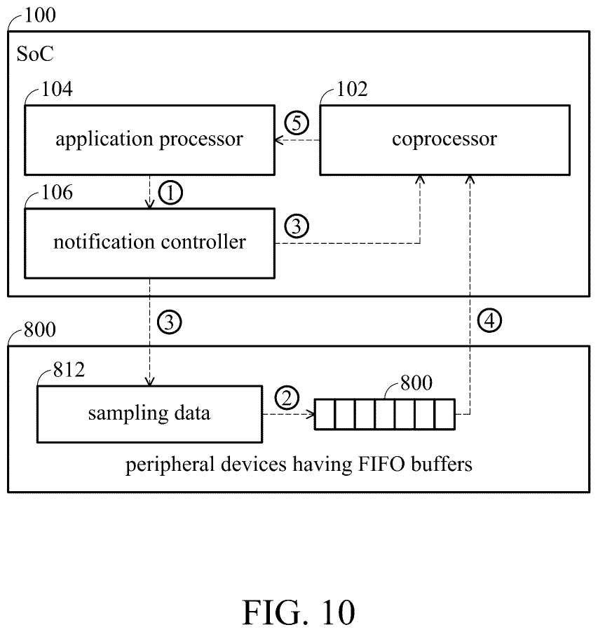

FIG. 10 shows a detail schematic diagram of the SoC 100 in FIG. 1 in accordance with some embodiments of the present invention. As shown in FIG. 10, the SoC 100 includes the coprocessor 102, the application processor 104, and the notification controller 106. The notification controller 106 is electrically connected to the coprocessor 102, the application processor 104, and peripheral devices 800. The notification controller 106 receive the synchronous signal and information of the predetermined period, such as action 1, counts the actual period before the synchronous signal during the next frame is generated, and outputs the notification signal to the coprocessor 102 and the peripheral devices 800, such as action 33. The peripheral devices 800 include an FIFO buffer 810. The FIFO buffer 810 is electrically connected to the notification controller 106 and the coprocessor 102. The FIFO buffer 810 stores data of the peripheral devices 800, such as action 2. In some embodiments, the peripheral devices 800 sample the data of its own based on the notification signal (that is, sampling data 812). The FIFO buffer 810 sends the data of the peripheral devices 800 to the coprocessor 102 in response to receiving the notification signal from the notification controller 106, such as action 4. The coprocessor 102 sends the data of the peripheral devices 810 to the application processor 104 in response to receiving the notification signal from the notification controller, such as action 5. FIG. 10 discloses some embodiments of the present invention to group the data from the peripheral devices with the synchronous signal.

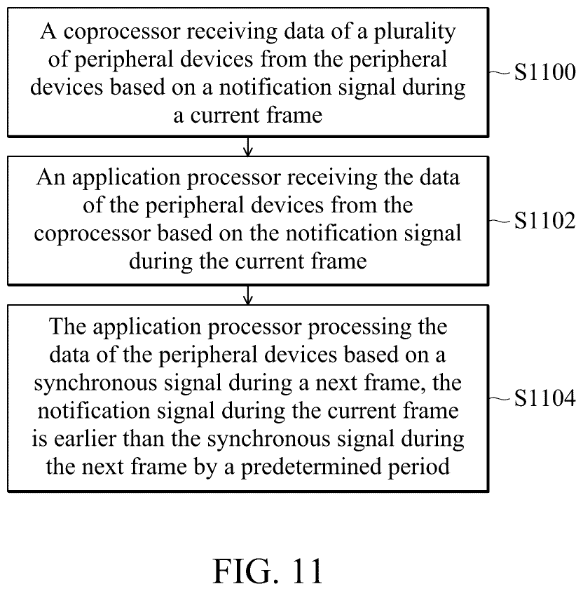

FIG. 11 shows a flow chart of a method to align and group data from multiple peripheral devices with a synchronous signal in accordance with some embodiments of the present invention. The method of the present invention is applicable to a SoC (for example, the SoC 100 in FIGS. 1˜10) including a coprocessor and an application processor, which are electrically connected to each other. The method includes the following steps. The coprocessor receives the data of the peripheral devices from the peripheral devices based on a notification signal during a current frame (step S1100). The application processor receives the data of the peripheral devices from the coprocessor based on the notification signal during the current frame (step S1102). The application processor processes the data of the peripheral devices based on a synchronous signal during the next frame. The notification signal during the current frame is earlier than the synchronous signal during the next frame by a predetermined period (step S1104). In some embodiments, the notification signal and the synchronous signal are periodic signals. The current frame and the next frame are defined between two adjacent synchronous signals. The current frame is earlier than the next frame, and the current frame is followed by the next frame.

In some embodiments, the SoC further includes a notification controller. The method of the present invention further includes the following steps. The notification controller generates the notification signal based on the synchronous signal from the application processor. The notification controller outputs the notification signal to the peripheral devices and the coprocessor.

In some embodiments, the method of the present invention further includes the following steps. The application processor configures a software timer to count the actual period before the synchronous signal during the next frame is generated. The application processor calls an ISR to output the notification signal to the peripheral devices and the coprocessor when the actual period is equal to the predetermined period.

In some embodiments, the method further includes the following steps. The application processor sends information of the predetermined period to the coprocessor. The coprocessor configures a software timer to count the actual period before the synchronous signal during the next frame is generated. The coprocessor calls an ISR to output the notification signal to the peripheral devices when the actual period is equal to the predetermined period.

In some embodiments, the SoC further includes a notification controller having a timeout timer, and the application processor includes an interrupt controller. The method of the present invention further includes the following steps. The timeout timer receives the synchronous signal and information of the predetermined period. The timeout timer counts the actual period before the synchronous signal during the next frame is generated. The timeout timer outputs the notification signal to the coprocessor, the application processor, and the peripheral devices having interrupt controllers when the actual period is equal to the predetermined period. The coprocessor receives the notification signal from the timeout timer. The application processor calls a task to output a control signal to the peripheral devices having no interrupt controllers based on the notification signal, so that the peripheral devices having no interrupt controllers send their data to the coprocessor based on the control signal.

In some embodiments, the SoC further includes a notification controller. The peripheral devices include a FIFO buffer. The method of the present invention further includes the following steps. The notification controller receives the synchronous signal and information of the predetermined period. The notification controller counts the actual period before the synchronous signal during the next frame is generated. The notification controller outputs the notification signal to the coprocessor and the peripheral devices having no first-in-first-out (FIFO) buffers when the actual period is equal to the predetermined period. The FIFO buffer stores data of the peripheral devices. The FIFO buffer sends the data of the peripheral devices to the coprocessor in response to receiving the notification signal from the notification controller. The coprocessor sends the data of the peripheral devices to the application processor in response to receiving the notification signal from the notification controller.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system-on-chip (SoC), comprising:
a coprocessor, configured to receive data of a plurality of peripheral devices from the peripheral devices based on a notification signal during a current frame; and
an application processor, electrically connected to the coprocessor, configured to receive the data of the peripheral devices from the coprocessor based on the notification signal during the current frame, and process the data of the peripheral devices based on a synchronous signal during the next frame,
wherein the notification signal during the current frame is earlier than the synchronous signal during the next frame by a predetermined period.

2. The SoC as claimed in claim 1, wherein the notification signal and the synchronous signal are periodic signals; the current frame and the next frame are defined between two adjacent synchronous signals; the current frame is earlier than the next frame; and the current frame is followed by the next frame.

3. The SoC as claimed in claim 1, further comprising:
a peripherals input controller, electrically connected to the coprocessor and the application processor, configured to receive the data of the peripheral devices from the peripheral devices and bypass the data of the peripheral devices to the coprocessor.

4. The SoC as claimed in claim 1, further comprising:
a notification controller, electrically connected to the coprocessor and the application processor, configured to generate the notification signal based on the synchronous signal from the application processor, and output the notification signal to the peripheral devices and the coprocessor.

5. The SoC as claimed in claim 4, wherein the notification controller comprises:
a counting register, configured to receive and bypass a clock signal;
a reference register, configured to receive and bypass the synchronous signal; and
a comparator, configured to receive the clock signal and the synchronous signal, and output the notification signal during the current frame to the peripheral devices and the coprocessor at beginning of the predetermined period before the synchronous signal during the next frame is received.

6. The SoC as claimed in claim 5, wherein the clock signal is generated by a crystal resonator comprised in the SoC.

7. The SoC as claimed in claim 1, wherein the application processor configures a software timer to count an actual period before the synchronous signal during the next frame is generated, and calls an interrupt service routine (ISR) to output the notification signal to the peripheral devices and the coprocessor when the actual period is equal to the predetermined period.

8. The SoC as claimed in claim 1, wherein the application processor sends information of the predetermined period to the coprocessor, and the coprocessor configures a software timer to count an actual period before the synchronous signal during the next frame is generated, and calls an interrupt service routine (ISR) to output the notification signal to the peripheral devices when the actual period is equal to the predetermined period.

9. The SoC as claimed in claim 1, further comprising:
a notification controller, comprising:
a timeout timer, electrically connected to the coprocessor, the application processor, and the peripheral devices, configured to receive the synchronous signal and information of the predetermined period, count an actual period before the synchronous signal during the next frame is generated, and output the notification signal to the coprocessor, the application processor, and the peripheral devices having interrupt controllers when the actual period is equal to the predetermined period;
wherein the application processor comprises:
an interrupt controller, configured to receive the notification signal from the timeout timer, and call a task to output a control signal to the peripheral devices having no interrupt controllers based on the notification signal, so that the peripheral devices having no interrupt controllers send their data to the coprocessor based on the control signal.

10. The SoC as claimed in claim 1, wherein the application processor configures a software timer to count an actual period before the synchronous signal during the next frame is generated, calls an interrupt service routine (ISR) to output the notification signal to the peripheral devices having interrupt controllers and the coprocessor when the actual period is equal to the predetermined period, and calls a task to output a control signal to the peripheral devices having no interrupt controllers based on the notification signal.

11. The SoC as claimed in claim 1, further comprising:
a notification controller, comprising:
a timeout timer, electrically connected to the coprocessor, the application processor, and the peripheral devices, configured to receive the synchronous signal, count an actual period before the synchronous signal during the next frame is generated, and output the notification signal to the coprocessor, the application processor, and the peripheral devices having microcontrollers when the actual period is equal to the predetermined period, so that a sampling rate of the peripheral devices having microcontrollers is calibrated by the notification signal;
wherein the coprocessor calibrates its sampling rate to sample the peripheral devices having no microcontrollers based on the notification signal.

12. The SoC as claimed in claim 1, further comprising:
a notification controller, electrically connected to the coprocessor, the application processor, and the peripheral devices, configured to receive the synchronous signal and information of the predetermined period, count an actual period before the synchronous signal during the next frame is generated, and output the notification signal to the coprocessor, and the peripheral devices having no first-in-first-out (FIFO) buffers when the actual period is equal to the predetermined period;
wherein the coprocessor comprises:
a FIFO buffer, electrically connected to the application processor and the peripheral devices having no FIFO buffers, configured to receive data of the peripheral devices having no FIFO buffers, and send the data of the peripheral devices having no FIFO buffers to the application processor in response to receiving the notification signal from the notification controller.

13. The SoC as claimed in claim 1, further comprising:
a notification controller, electrically connected to the coprocessor, the application processor, and the peripheral devices, configured to receive the synchronous signal and information of the predetermined period, count an actual period before the synchronous signal during the next frame is generated, and output the notification signal to the coprocessor, and the peripheral devices;
wherein the peripheral devices comprise:
a FIFO buffer, electrically connected to the notification controller and the coprocessor, configured to store data of the peripheral devices, and send the data of the peripheral devices to the coprocessor in response to receiving the notification signal from the notification controller;
wherein the coprocessor sends the data of the peripheral devices to the application processor in response to receiving the notification signal from the notification controller.

14. A method to align and group data from multiple peripheral devices with a synchronous signal, applicable to a SoC comprising a coprocessor and an application processor, which are electrically connected to each other, comprising:
by the coprocessor, receiving the data of the peripheral devices from the peripheral devices based on a notification signal during a current frame;
by the application processor, receiving the data of the peripheral devices from the coprocessor based on the notification signal during the current frame; and
by the application processor, processing the data of the peripheral devices based on a synchronous signal during the next frame,
wherein the notification signal during the current frame is earlier than the synchronous signal during the next frame by a predetermined period.

15. The method as claimed in claim 14, wherein the notification signal and the synchronous signal are periodic signals; the current frame and the next frame are defined between two adjacent synchronous signals; the current frame is earlier than the next frame; and the current frame is followed by the next frame.

16. The method as claimed in claim 14, wherein the SoC further comprises a notification controller, and the method further comprises:
by the notification controller, generating the notification signal based on the synchronous signal from the application processor; and
by the notification controller, outputting the notification signal to the peripheral devices and the coprocessor.

17. The method as claimed in claim 14, further comprising:
by the application processor, configuring a software timer to count an actual period before the synchronous signal during the next frame is generated; and
by the application processor, calling an interrupt service routine (ISR) to output the notification signal to the peripheral devices and the coprocessor when the actual period is equal to the predetermined period.

18. The method as claimed in claim 14, further comprising:
by the application processor, sending information of the predetermined period to the coprocessor;
by the coprocessor, configuring a software timer to count an actual period before the synchronous signal during the next frame is generated; and
by the coprocessor, calling an interrupt service routine (ISR) to output the notification signal to the peripheral devices when the actual period is equal to the predetermined period.

19. The method as claimed in claim 14, wherein the SoC further comprises a notification controller having a timeout timer, and the application processor comprises an interrupt controller, wherein the method further comprises:
by the timeout timer, receiving the synchronous signal and information of the predetermined period;
by the timeout timer, counting an actual period before the synchronous signal during the next frame is generated;
by the timeout timer, outputting the notification signal to the coprocessor, the application processor, and the peripheral devices having interrupt controllers when the actual period is equal to the predetermined period;
by the application processor, receiving the notification signal from the timeout timer; and
by the application processor, calling a task to output a control signal to the peripheral devices having no interrupt controllers based on the notification signal, so that the peripheral devices having no interrupt controllers send their data to the coprocessor based on the control signal.

20. The method as claimed in claim 14, wherein the SoC further comprises a notification controller; the peripheral devices comprise a FIFO buffer, and the method further comprises:
by the notification controller, receiving the synchronous signal and information of the predetermined period;
by the notification controller, counting an actual period before the synchronous signal during the next frame is generated;
by the notification controller, outputting the notification signal to the coprocessor and the peripheral devices having no first-in-first-out (FIFO) buffers when the actual period is equal to the predetermined period;
by the FIFO buffer, storing data of the peripheral devices;
by the FIFO buffer, sending the data of the peripheral devices to the coprocessor in response to receiving the notification signal from the notification controller; and
by the coprocessor, sending the data of the peripheral devices to the application processor in response to receiving the notification signal from the notification controller.
